(19) United States
(12) Patent Application Publication
(10) Pub. No.: US 2012/0047782 A1
(43) Pub. Date: Mar. 1, 2012

(54) Rally Banner

(76) Inventors: Eddie Mishan, New York, NY (US); Alex Fonseca, Mine Hill, NJ (US); Thomas A. Cadawas, Staten Island, NY (US)

(21) Appl. No.: 12/862,158

(22) Filed: Aug. 24, 2010

(51) Int. Cl. G09F 17/00

(52) U.S. Cl. 40/604

(57) ABSTRACT

A collapsible rally banner assembly includes a closed resilient loop having a folded small-diameter position with multiple turns of the loop overlapping each other, and an large-diameter display position with one continuous turn of the loop laying substantially in a plane, a flexible circular material covering having an outer circular perimeter tube that receives the loop. The covering has at least one smooth glossy surface that is adapted to be written on by a dry erasable marker and, from which the writing can be erased using a cloth. The assembly also includes a flexible pouch having side walls and an opening of a size for receiving the loop in its folded position but not in its large-diameter display position and a dry erasable marker for erasably writing on the at least one surface.

### FIELD AND BACKGROUND OF THE INVENTION

The present invention relates generally to the field of sporting event banners and, in particular, to a rally banner for use by fans at a sporting even to show their support for their team.

U.S. Pat. No. 6,607,325 to Hori teaches a dry-erase marker, which is sold under the QUARTET trademark. That patent is directed to a marker with an interior partitioned reservoir and is owned by HICS Corporation of Saitama, Japan. HICS Corporation owns two other U.S. patents in the field of markers, namely, U.S. Pat. Nos. 6,474,895 and 7,077,593. Also see an erasable marker brand called INC by Peachtree Playthings of Atlanta, Ga. 31139, www.peachtreeplaythings.com.

A large family of patents are directed to inventions by inventor Yu Zheng, many of which are assigned to Patent Category Corporation of Walnut, Calif. The majority of the patents to Zheng deal with variations on the theme of utilizing collapsible wire frames with flexible fabric stretched across the frames for producing a wide variety of useful products.

The earliest of these appears to be U.S. Pat. No. 4,815,784, for an automobile sun shield. This reference is directed to a collapsible elongated sun shield including, a plurality of adjacent collapsible flexible loop members. A fabric covering material is provided for substantially covering the flexible loop members. The loop members substantially support the fabric in particular areas to provide for loop portions and an interconnecting portion forming a hinge between each loop portion. The loop portions of the fabric are folded on top of each other about the hinge portion to have the loop members and associated fabric overlaying each other. The overlaying loop members are collapsed by twisting and folding to form a plurality of concentric loop rings and layers of fabric to substantially reduce the size of the sunshield.

One of the more recent applications by Zheng has been published as U.S. Patent Publication No. 2010/0059514 for a collapsible storage device. This application is directed to a collapsible structure having first and second flexible loop members, each loop member defining a closed loop and having a first side and an opposing second side, each loop member adapted to assume an expanded position and a collapsed position, with the two loop members overlapping each other at a first overlapping point along the first sides of the loop members, and at a second overlapping point along the second sides of the loop members. The loop members are adapted to assume a deployed position in which one loop member is disposed at an angle with respect to the other loop member at the overlapping points, so that the structure defines a top side, four vertical sides, and a bottom side when the loop members are in the deployed position. The structure also includes a flexible wall extending across the four vertical sides and the bottom side to define an interior space.

Flexible, foldable wire hoops with white fabric are also used as photograph light reflector such as those sold by Lastolite. Lastolite manufactures various collapsible light reflectors.

A patent application assigned to Lastolite and published as U.S. Patent Publication No. 2007/0189756 is directed to a target suitable for setting the exposure and white balance of a photographic digital camera. The target disclosed therein comprises a target surface that has a reflectance of 18% for all wavelengths of visible light. The reference teaches a target surface is provided with a feature upon which the camera is able to focus.

However, none of the above foldable flexible loop structures include an erasable surface for the flexible fabric.

U.S. Pat. No. 6,251,500 owned by RJF International Corporation, teaches decorative vinyl wall covering for use in decorating walls found in homes and other structures which is specifically designed to be writable and erasable.

Nothing in the prior art suggests a foldable loop that has an erasable surface so it may be carried to an event while in a folded configuration, and then opened to a large size that is easily visible and on which a user may write, erase and rewrite any message the user wishes.

### SUMMARY OF THE INVENTION

It is an object of the present invention to provide collapsible rally banner assembly including a closed resilient loop having a folded small-diameter position with multiple turns of the loop overlapping each other, and a large-diameter display position with one continuous turn of the loop laying substantially in a single plane to spread an erasable flexible surface on which message can be written.

It is also an object of the present invention to provide a collapsible rally banner assembly including a closed resilient loop having a flexible circular material covering having an outer circular perimeter tube that receives the loop, the covering having at least one smooth glossy surface that is adapted to be written on by a dry erasable marker and, from which writing by the dry erasable marker, can be erased using a cloth.

It is a further object of the present invention to provide a collapsible rally banner assembly including a closed resilient loop having a flexible pouch with side walls and an opening of a size for receiving the loop in its folded position, but not in its open display position, and a dry erasable marker for erasably writing on the erasable surface.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of a rally banner according to the present invention, in a folded orientation or position;

FIG. 2 is a partial perspective view of the rally banner of the present invention in an open display position or orientation, with a portion cut away to show an underlying structure;

FIG. 3 is a side elevational view of the rally banner of the present invention in a semi-folded configuration, showing a transitional state between its open and closed positions; and

FIG. 4 is a perspective view of a rally banner assembly of the present invention, with a banner in both its folded or closed position and a second banner its unfolded or open positions, along with accessories of the assembly of the invention.

### DESCRIPTION OF THE PREFERRED EMBODIMENTS

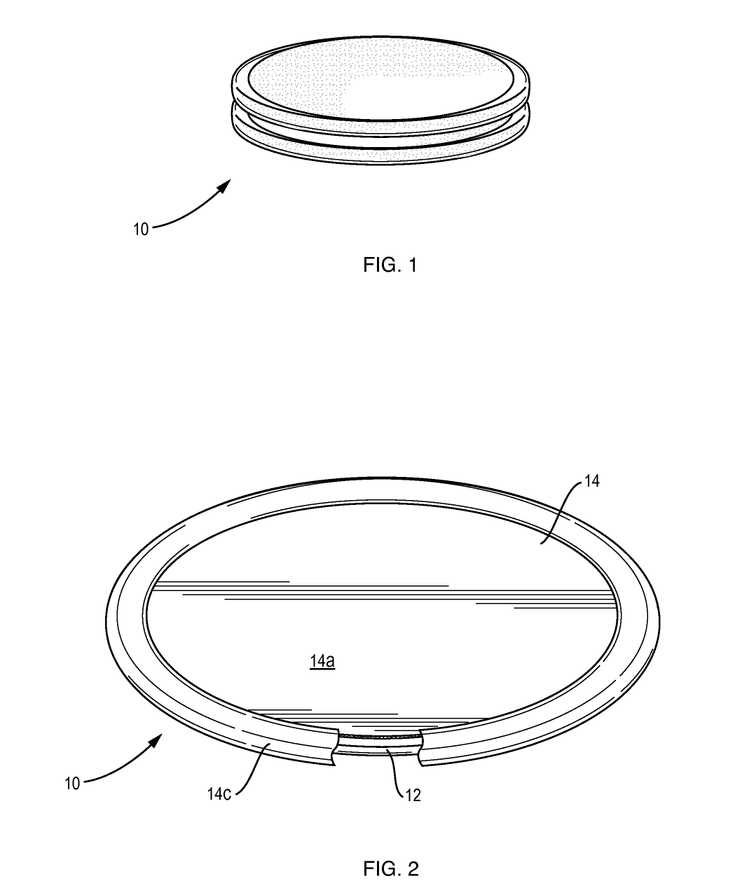

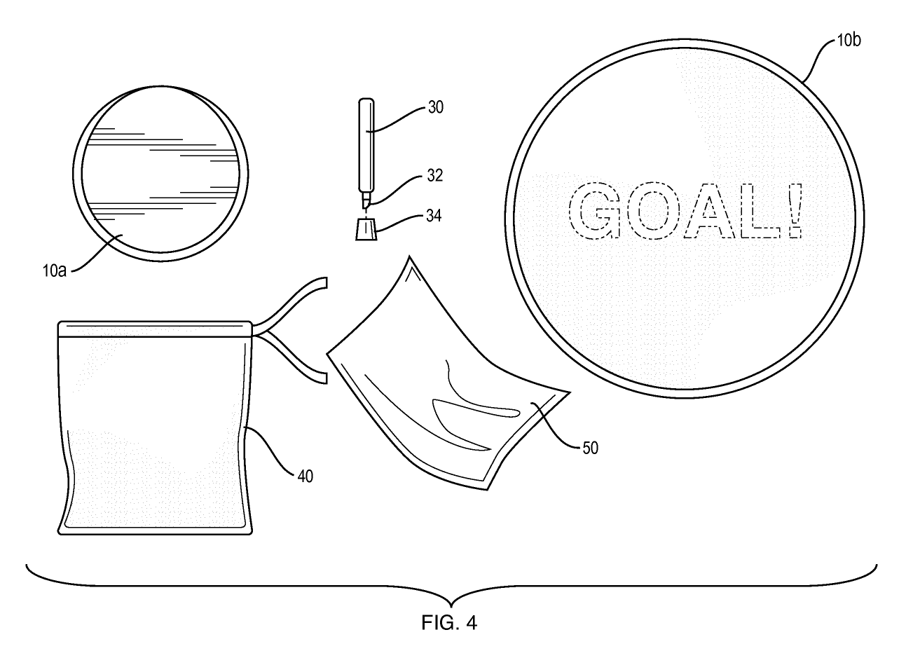

Referring now to the drawings, in which like reference numerals are used to refer to the same or similar elements, FIG. 1 shows a foldable sign or banner 10 made up of a closed loop or hoop of flexible steel or other strong flexible resilient material 12, forming a frame in a circular configuration enclosed in a nylon or other smooth flexible material 14. The sign 10, or 10a in FIG. 4, can be twisted at both ends of its diameter as shown in FIG. 3, to assume the significantly smaller circular configuration shown in FIG. 1. In this smaller configuration, the sign can be carried in a rectangular pouch 30, shown in the assembly drawing of FIG. 4, by a person, e.g. a sports fan, so the assembly may easily be carried to a sporting or other event.

The invention is comprised of the following components: a flat metal ring which is about 32 inches in diameter and about ¼ inch wide; a nylon or polyester material covering 14 that has an outer tube 14c that is sewn around and over the metal ring 12. The material is blank or printed on one side 14b that may have a mat or glossing surface texture, but the covering 14 also has a smooth glossing writable opposite surface 14a that is of a type that can be written on using a dry erase marker 30 of known type, with any large message a fan wishes the publish at the event, or the players and other spectators to see. The message may then be erased or changed at will, e.g. using a paper or cloth wipe 50 that is also part of the assembly.

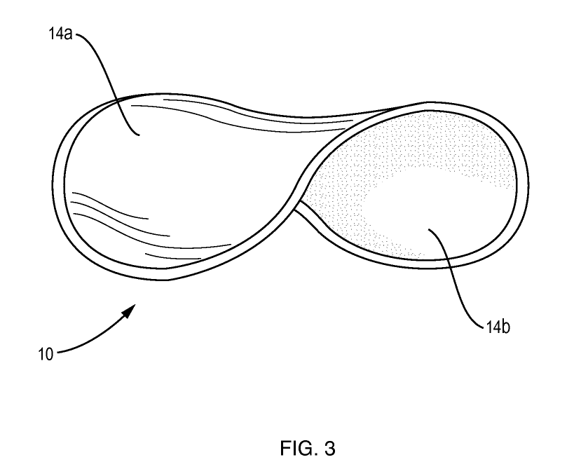

The banner is twisted at the opposite ends of its diameter to assume its smaller folded state 10a, shown in FIG. 4, so that it can be stored in a fabric or sheet material pouch 40 with the marker 30 that first has its writing tip 32 covered by a cap 34, placed in the pouch as well. When removed from the pouch, the resilience of the loop 12 causes it to open to a significantly larger size shown in FIG. 2 and at 10b in FIG. 4 to reveal a message sign, e.g. GOAL!

A foldable sign or banner is comprised of a closed loop flexible steel frame 12 in a circular configuration enclosed in the, e.g. nylon material cover 14. The individual holds the circular spring action frame and allows it to pop open revealing the sign or banner.

Thus, the collapsible rally banner assembly of the invention comprises a closed resilient loop 12 having a folded small-diameter position of about 11 inches for example, with multiple, e.g. three, turns of the loop overlapping each other, and a large-diameter display position of about 32 inches for example, with one continuous turn of the loop laying substantially in a plane. The flexible circular material covering 14 having its outer circular perimeter tube 14c that receives the loop 12, has at least one smooth glossy surface 14a that is adapted to be written on by a dry erasable marker 30 and, from which writing by the dry erasable marker, can be erased using a cloth 50. The INC brand erasable marker by Peachtree Playthings or other commercially available erasable marker with cap may be use with the invention.

The flexible pouch 40 with side walls and an opening of a size for receiving the loop 12 in its folded position is included and cannot receive the banner in its open display position. The assembly includes the dry erasable marker 30 for erasably writing on the at least one surface 14a.

While a specific embodiment of the invention has been shown and described in detail to illustrate the application of the principles of the invention, it will be understood that the invention may be embodied otherwise without departing from such principles.

What is claimed is:

1. A collapsible display device upon which erasable indicia or messages may be written, said device comprising:
a closed resilient loop having a folded, small-diameter position with multiple turns of the loop overlapping one another, and a large-diameter display position with one continuous turn of the loop laying substantially in a plane; and
a flexible circular material covering having an outer circular perimeter tube that receives the loop, the covering having at least one smooth glossy surface that is adapted to receive and display writing from a dry erasable marker and, from which writing by the dry erasable marker, can be erased using a cloth.

2. The collapsible rally banner assembly of claim 1, wherein the closed resilient loop is made of a metal.

3. The collapsible rally banner assembly of claim 2, wherein the metal is steel.

4. The collapsible rally banner assembly of claim 1, wherein said small-diameter position comprises three turns of the loop overlapping one another.

5. The collapsible rally banner assembly of claim 1, wherein the large-diameter display position has a diameter which is in the range of 2.5-3.0 times the diameter of the small-diameter position.

6. The collapsible rally banner assembly of claim 1, further comprising a flexible pouch having side walls and an opening of a size for receiving the loop in its folded position, but not in its large-diameter display position.

7. The collapsible rally banner assembly of claim 1, further comprising a dry erasable marker for erasably writing on the at least one smooth glossy surface.

8. The collapsible rally banner assembly of claim 7, further comprising a cap for closing a writing tip of the dry erasable marker.

9. The collapsible rally banner assembly of claim 1, further comprising a wipe for erasing the writing from the flexible circular material covering.

10. The collapsible rally banner assembly of claim 1, wherein the flexible circular material covering is nylon.

11. The collapsible rally banner assembly of claim 1, wherein the flexible circular material covering is polyester.

12. A collapsible rally banner assembly comprising:
a closed resilient loop having a folded small-diameter position with multiple turns of the loop overlapping one another, and a large-diameter display position with one continuous turn of the loop laying substantially in a plane;
a flexible circular material covering having an outer circular perimeter tube that receives the loop, the covering having at least one smooth glossy surface that is adapted to receive and display writing from a dry erasable marker and, from which writing by the dry erasable marker, can be erased using a cloth;
a flexible pouch having side walls and an opening of a size for receiving the loop in its folded position, but not in its large-diameter display position; and
a dry erasable marker for erasably writing on the at least one surface.

13. The collapsible rally banner assembly of claim 12, wherein the closed resilient loop is made of a metal.

14. The collapsible rally banner assembly of claim 12, wherein the metal is steel.

15. The collapsible rally banner assembly of claim 1, wherein said small-diameter position comprises three turns of the loop overlapping one another.

16. The collapsible rally banner assembly of claim 12, wherein the large-diameter display position has a diameter which is in the range of 2.5-3.0 times the diameter of the small-diameter position.

17. The collapsible rally banner assembly of claim 12, including a cap for closing a writing tip of the dry erasable marker.

18. The collapsible rally banner assembly of claim 12, including a wipe for erasing the writing from the flexible circular material covering.

19. The collapsible rally banner assembly of claim 12, wherein the flexible circular material covering is nylon.

20. The collapsible rally banner assembly of claim 12, wherein the flexible circular material covering is polyester.
